(19) United States
(12) Patent Application Publication
(10) Pub. No.: US 2016/0117908 A1
(43) Pub. Date: Apr. 28, 2016

(54) SYSTEMS AND METHODS FOR COMMUNICATING DATA VIA LIGHT PULSES

(71) Applicant: Astec International Limited, Kowloon (HK)

(72) Inventors: Donald Cedrick Yuchongtian Ongyanco, Quezon City (PH); Colin Cameron, Quezon City (PH)

(21) Appl. No.: 14/878,542

(22) Filed: Oct. 8, 2015

Related U.S. Application Data
(60) Provisional application No. 62/069,682, filed on Oct. 28, 2014.

(51) Int. Cl. G08B 21/18; H04B 10/116; G08B 5/38

(52) U.S. Cl. CPC G08B 21/185; G08B 5/38; H04B 10/116

(57) ABSTRACT

A method for communicating data from a device to an object external to the device includes encoding one or more operating parameters of the device into a data sequence, and activating a light source of the device to generate a series of light pulses to represent the data sequence to communicate the encoded one or more operating parameters to an object external to the device. Another method includes capturing with a camera a series of light pulses from a light source of a device, and decoding the series of light pulses into data representing one or more operating parameters of the device. Example devices and systems employing the methods are also disclosed.

### CROSS-REFERENCE TO RELATED APPLICATION

This application claims the benefit and priority of U.S. Provisional Application No. 62/069,682 filed Oct. 28, 2014. The entire disclosure of the above application is incorporated herein by reference.

### FIELD

The present disclosure relates to systems and methods for communicating data via light pulses.

### BACKGROUND

This section provides background information related to the present disclosure which is not necessarily prior art.

A power supply typically includes an LED for indicating a particular status of the power supply. The LED can change colors and/or turn on and off to indicate to a user a fault has occurred. The user may then further analyze the power supply to determine the specific fault.

### SUMMARY

This section provides a general summary of the disclosure, and is not a comprehensive disclosure of its full scope or all of its features.

According to one aspect of the present disclosure, a power supply includes a power circuit for converting an input voltage and current to an output voltage and current, a light source, and a control circuit coupled to the power circuit and the light source. The control circuit is configured to monitor one or more operating parameters of the power supply, encode the one or more operating parameters into a data sequence, and activate the light source to generate a series of light pulses to represent the data sequence for communicating the encoded one or more operating parameters to an object external to the power supply.

According to another aspect of the present disclosure, a method for communicating data from a power supply to an object external to the power supply is disclosed. The method includes encoding one or more operating parameters of the power supply into a data sequence, and activating a light source of the power supply to generate a series of light pulses to represent the data sequence to communicate the encoded one or more operating parameters to an object external to the power supply.

According to yet another aspect of the present disclosure, a device includes a processor, memory, a camera, and a software application stored in said memory and executable by the processor. The software application is configured to decode a series of light pulses from a light source of a power supply captured by the camera into data representing one or more operating parameters of the power supply.

According to another aspect of the present disclosure, a computer-implemented method for communicating data from a power supply to a device external to the power supply is disclosed. The method includes capturing with a camera of the device a series of light pulses from a light source of the power supply. The series of light pulses represents an encoded data sequence of one or more operating parameters of the power supply. The method further includes decoding the series of light pulses into data representing the one or more operating parameters of the power supply.

According to yet another aspect of the present disclosure, a system includes a power supply having a power circuit for converting an input voltage and current to an output voltage and current, a light source, a control circuit coupled to the power supply and the light source, and a device. The control circuit is configured to monitor the one or more operating parameters of the power supply, encode the one or more operating parameters into a data sequence, and activate the light source to generate a series of light pulses to represent the data sequence. The device includes a camera, a processor, memory, and a software application stored in said memory and executable by the processor. The software application is configured to decode the series of light pulses captured by the camera into data representing the one or more operating parameters of the power supply.

According to another aspect of the present disclosure, a device includes a light source and a control circuit coupled to the light source. The control circuit is configured to encode one or more operating parameters of the device into a data sequence, and activate the light source to generate a series of light pulses to represent the data sequence for communicating the encoded one or more operating parameters to an object external to the device.

According to yet another aspect of the present disclosure, a method for communicating data from a device to an object external to the device is disclosed. The method includes encoding one or more operating parameters of the device into a data sequence and activating a light source of the device to generate a series of light pulses to represent the data sequence to communicate the encoded one or more operating parameters to an object external to the device.

According to another aspect of the present disclosure, a device includes a processor, memory, a camera, and a software application stored in said memory and executable by the processor. The software application is configured to decode a series of light pulses from a light source of another device captured by the camera into data representing one or more operating parameters of other device.

According to yet another aspect of the present disclosure, a computer-implemented method for communicating data from a first device to a second device is disclosed. The method includes capturing with a camera of the second device a series of light pulses from a light source of the first device. The series of light pulses represent an encoded data sequence of one or more operating parameters of the first device. The method further includes decoding the series of light pulses into data representing the one or more operating parameters of the first device.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a power supply including a power circuit, a control circuit and a light source according to one example embodiment of the present disclosure.

FIG. 2 is a block diagram of a power supply including an LED light source according to another embodiment of the present disclosure.

FIG. 3 is a block diagram of a device including a camera, a processor, memory, and a software application according to yet another embodiment of the present disclosure.

FIG. 4 is a block diagram of a system including a power supply including one LED light source and the device of FIG. 3 according to another embodiment of the present disclosure.

FIG. 5 is a block diagram of a system including a power supply including two LED light sources and the device of FIG. 3 according to yet another embodiment of the present disclosure.

FIG. 6 is an image of a system including two power supplies each having an LED light source and a smartphone capturing and decoding a light pulse from one LED light source according to another embodiment of the present disclosure.

FIG. 7 is the system of FIG. 6 where the smartphone is capturing and decoding another light pulse from one LED light source.

FIG. 8 is the system of FIG. 6 where the smartphone is capturing and decoding a light pulse from each LED light source according to another embodiment of the present disclosure.

FIG. 9 is the system of FIG. 6 where the smartphone is capturing and decoding another light pulse from each LED light source.

FIG. 10 is an image of a system including two power supplies each having an LED light source and a laptop capturing and decoding a light pulse from each LED light source according to another embodiment of the present disclosure.

FIG. 11 is a block diagram of a device including a control circuit and a light source according to yet another embodiment of the present disclosure.

FIG. 12 is a block diagram of a device display showing various operating parameter(s) of a device according to another embodiment of the present disclosure.

Corresponding reference numerals indicate corresponding parts or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

According to one aspect of the present disclosure, methods are provided for communicating data from a power supply to an object external to the power supply. The methods may include, for example, encoding one or more operating parameters of the power supply into a data sequence, and activating a light source of the power supply to generate a series of light pulses to represent the data sequence to communicate the encoded one or more operating parameters to an object external to the power supply.

By encoding operating parameters of a power supply into a data sequence and activating a light source to generate a series of light pulse to represent the data sequence, information related to the power supply may be communicated to, for example, a device external the power supply without utilizing conventional interfaces such as a wired data interface, etc. In many cases, this information may be impractical and in some cases, impossible, to communicate via these conventional interfaces. As such, the power supply, components (e.g., power circuits, discrete electrical components, etc.) in the power supply, etc. may be monitored, a particular fault condition may be determined, an alarm may be triggered, and/or appropriate action may be taken if necessary.

For example, the power supply may include various operating parameter(s) which may be monitored. In some embodiments, the operating parameter(s) may be monitored by sensing an output, an input, a temperature, etc. of the power supply, a power circuit of the power supply, one or more circuit components of the power supply, etc. Additionally and alternatively, the operating parameter(s) may include a power supply setting, a power supply status, a control circuit setting, a control circuit status, etc. For example, the power supply setting may indicate a mode of operation and the power supply status may indicate a particular condition (e.g., a failure condition, normal operating condition, etc.) of the power supply, components in the power supply, etc.

In some embodiments, the operating parameters of the power supply may be encoded into the data sequence in a digital form. For example, one operating parameter may be encoded as a series of binary bits while other operating parameters may be encoded as a different series of binary bits. As such, each operating parameter may have a defined data sequence of one or more binary bits, each specific value of an operating parameter may have a defined data sequence of one or more binary bits, etc. Alternatively, the operating parameters of the power supply may be encoded into the data sequence in another suitable manner, format, etc.

In such cases, the light source may generate the series of light pulses corresponding to a defined data sequence of one or more binary bits. For example, one or more binary bits, bytes, etc. may be represented by a particular color of the light pulse. As such, one light pulse may be yellow to represent one portion (e.g., a bit such as a “1” or a “0”, a byte, etc.) of the data sequence and another light pulse may be blue to represent another portion of the data sequence.

For example, the light source may follow the following protocol to communicate the encoded operating parameter(s). Initially, the light source may be deactivated for a default period of time (e.g., one millisecond, four seconds, ten seconds, etc.). Next, a first byte of data may be communicated by forcing the light source to blink (to generate a light pulse) eight times to represent eight bits in the first byte. Each on-time duration and/or each off-time duration of the light source may be about one millisecond, 500 milliseconds, one second, or any other suitable period of time. In this particular example, each light pulse may be a particular color to represent a particular bit value. As such, a “1” value may be represented by a red light pulse and a “0” value may be represented by a green light pulse. For example, if the first byte had the binary value of “0000 0001” (e.g., a hexadecimal value of “01”), the light source would be activated to generate seven green light pulses and one red light pulse.

The light source may then be deactivated for another default period of time (e.g., one millisecond, two seconds, four seconds, etc.). After which, a second byte of data may be communicated by forcing the light source to blink another eight times (as explained above) to represent eight bits in the second byte. For example, if the second byte had the binary value of “0000 1010” (e.g., a hexadecimal value of “0A”), the light source would be activated to generate four green light pulses, one red light pulse, one green light pulse, one red light pulse, and then one green light pulse.

This cycle may be repeated as desired depending on, for example, the number of bytes to communicate. Additionally, it may be desirable to output the most significant bit (MSB) first for each byte communicated.

In other example embodiments, a particular color may represent two bits of a byte. For example, a green light pulse may represent “01”, an orange light pulse may represent “10” and a red light pulse may represent “11.” In this case, if a byte had the binary value of “0100 1011” (e.g., a hexadecimal value of “4B”), the light source may be activated to generate a green light pulse, deactivated to represent “00”, activated to generate an orange light pulse, and activated to generate an red light pulse.

Additionally and alternatively, the light pulses may be modulated (e.g., a modulated duty cycle, etc.) to represent different portions of the data sequence. For example, one or more binary bits may be represented by an on-time duration of a light pulse, an off-time duration between light pulses, etc. In such cases, a particular on-time duration and/or off-time duration may represent one portion of the data sequence and another on-time duration and/or off-time duration may represent another portion of the data sequence.

This cycle may be repeated as desired depending on, for example, the number of bytes to communicate. Additionally, it may be desirable to output the most significant bit (MSB) first for each byte communicated.

Alternatively, any other suitable parameter of the light pulse may be utilized to represent different portions of the data sequence if desired.

In some example embodiments, encoding the operating parameter(s) and/or activating the light source to generate the series of light pulses may be continuous. Alternatively, encoding the operating parameter(s) and/or activating the light source to generate the series of light pulses may be in response to a defined event. The defined event may include, for example, a user command, a sensed parameter, a power supply mode, a period of time, etc. As such, encoding and/or activating the light source may not begin until a particular event occurs.

The object external to the power supply may be any suitable object. For example, the object may be an individual monitoring the power supply light source. In such cases, the light source may be switched at a rate slow enough to allow the individual to recognize each state change. As such, the on-time durations of the light pulses and/or the off-time durations between light pulses may be extended as necessary. In other embodiments, the object may be a device for capturing and decoding the series of light pulses as further explained below.

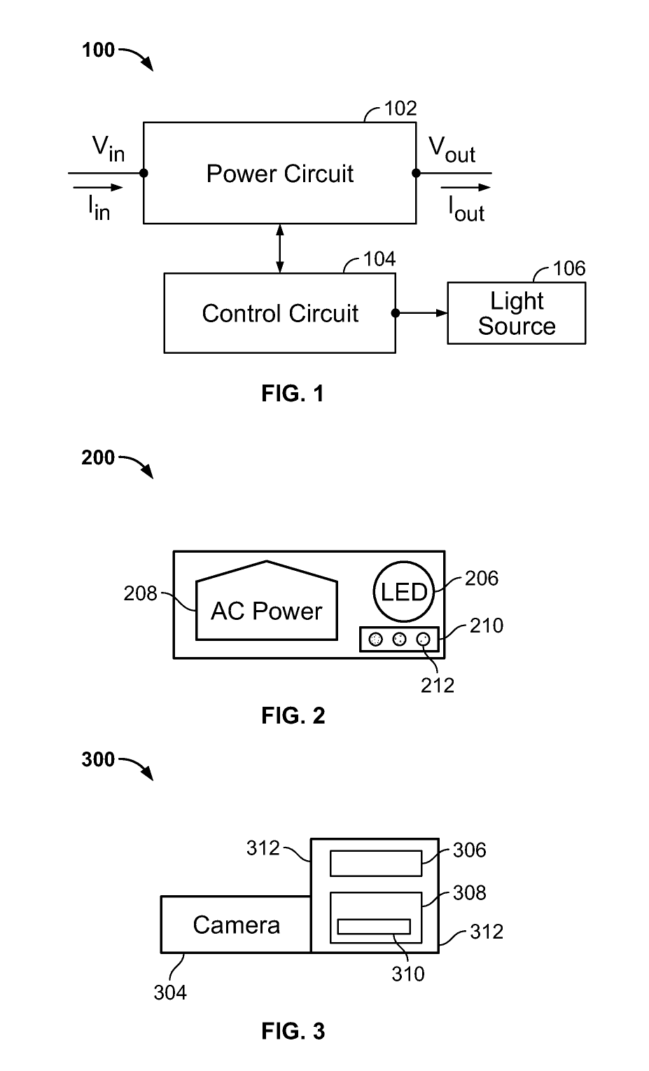

One or more of the methods disclosed herein may be implemented by a control circuit including, for example, any one of the control circuits disclosed herein and/or another suitable control circuit. For example, FIG. 1 illustrates a power supply according to one example embodiment of the present disclosure and is indicated generally by reference number 100. As shown in FIG. 1, the power supply 100 includes a power circuit 102 for converting an input voltage Vin and current Iin to an output voltage Vout and current Iout, a light source 106, and a control circuit 104 coupled to the power circuit 102 and the light source 106. The control circuit 104 monitors operating parameter(s) of the power supply 100, encodes the operating parameter(s) into a data sequence, and activates the light source 106 to generate a series of light pulses to represent the data sequence for communicating the encoded operating parameter(s) to an object (not shown) external to the power supply 100 as explained above.

For example, the control circuit 104 may monitor the input voltage and current, and the output voltage and current by sensing the input voltage Vin, the input current Iin, the output voltage Vout, the output current Iout, etc. as explained above.

Additionally, the operating parameter(s) may be encoded into the data sequence in any suitable format including, for example, a digital form (as explained above), etc. The control circuit 104 may then control the light source 106 such that the light pulses are varied (e.g., varying an on-time duration of each light pulse and/or an off-time duration between light pulses, etc.), have different colors, etc. to represent the data sequence.

In some embodiments, the control circuit 104 may monitor the operating parameter(s), encode the operating parameter(s) and/or activate the light source 106 continuously, in response to a defined event, etc. as explained above. For example, the control circuit 104 may monitor the operating parameter(s) continuously but encode the operating parameter(s) and activate the light source 106 in response to a user command (as further explained below).

For example, FIG. 2 illustrates a power supply 200 substantially similar functionality to the power supply 100 of FIG. 1. The power supply 200, however, includes an LED 206 for the light source, a slot 210 to access one or more pins 212, and an AC power input interface 208 for receiving an AC voltage and current. Although not shown, the power supply 200 may include a control circuit and a power circuit substantially similar to the control circuit 104 and the power circuit 102 of FIG. 1. For example, at least a portion of the power circuit in the power supply 200 may include an AC/DC rectifier for receiving the AC voltage and current.

At least one of the pins 212 may function as an on/off switch to enable the LED 206. For example, one of the pins 212 may be shorted to enable the LED 206. This may be required before the control circuit activates the LED 206 to generate a series of light pulses as explained above. Thus, in the example of FIG. 2, the control circuit activates the LED 206 in response to switching one of the pins 212 (e.g., a user command). Alternatively, and as explained above, the control circuit may activate the LED 206 to generate a series of light pulses without a user command.

In other examples, computer-implemented methods for communicating data from a power supply and/or any other suitable device (e.g., a computer server, and a motor, etc.) to a device external to the power supply may include capturing with a camera of the device a series of light pulses from a light source of the power supply. The series of light pulses may represent an encoded data sequence of operating parameter(s) (as explained above) of the power supply. The methods may further include decoding the series of light pulses into data representing the one or more operating parameters of the power supply.

In some embodiments, the device may be in communication with the power supply through only the camera. In such cases, the device may not be coupled to the power supply via another type of a wireless data connection, a wired connection, etc. In other embodiments, the device may be in communication with the power supply through the camera, and a wired connection and/or a wireless data connection. In such examples, information related to the power supply may be transmitted to the device through any one or more of the captured light pulses, the wired connection and/or another wireless data connection.

Additionally, the computer-implemented methods may include displaying the data representing the operating parameter(s) of the power supply (and/or any other suitable device). For example, the device including the camera for capturing the series of light pulses may include a display for displaying the data. Additionally and alternatively, the device may communicate this data to another suitable device to display the data.

For example, FIG. 12 illustrates a display 1200 displaying a sensed temperature, a sensed output voltage, a control circuit (e.g., a processor, etc.) usage percent, and a control circuit usage history of the power supply (and/or any other suitable device). The display 1200 also includes options to view other operating parameter(s) such as a sensed current and power (e.g., output power, power used, etc.). Additionally and alternatively, the display 1200 may display more or less operating parameter(s) as disclosed herein if desired. As explained above, the display 1200 may be a display of the device including the camera and/or another suitable device.

Capturing the series of light pulses from the light source and/or decoding the series of light pulses into data representing the operating parameter(s) may be continuous. For example, the captured series of light pulses may be decoded in real-time. Alternatively, capturing the series of light pulses and/or decoding the series of light pulses may be in response to a defined event. As explained above, the defined event may include, for example, a user command, a sensed parameter, a period of time, etc.

In some example embodiments, the captured series of light pulses may be stored. For example, the captured series of light pulses may be stored in memory of the device including the camera, remote memory, etc. As such, the captured series of light pulses may be decoded (and analyzed) at a later time, compared to one or more other series of light pulses, etc.

One or more of the computer-implemented methods disclosed herein may be implemented by any suitable control circuit including, for example, a processor, etc. For example, FIG. 3 illustrates a device 300 including a camera 304, a processor 306, memory 308, and a software application 310 for decoding a series of light pulses from a light source (not shown) captured by the camera 304 into data representing one or more operating parameters of another device (e.g., a power supply, a computer server, a motor, etc.) as explained above. For example, the software application 310 may be able to decode the series of light pulses by processing the captured images, video, etc. frame by frame. As such, the software application 310 can determine the color of the light pulse, an on-time duration of a particular light pulse, an off-time duration between light pulses, default periods of time before, between, and/or after data sequences, etc. as explained above.

Additionally, the software application 310 may include instructions for performing any one or more of the above explained computer-implemented methods.

The device 300 includes a housing 312 for enclosing the processor 306 and the memory 308. As shown in FIG. 3, the camera 304 is positioned on an exterior surface of the housing 312. It should be apparent, however, that the camera 304 may be positioned on another surface (e.g., an interior surface, another exterior surface, etc.) of the device 300 without departing from the scope of the disclosure. Alternatively and additionally, the camera 304 may be remote from the device 300, moveable about the device 300, etc.

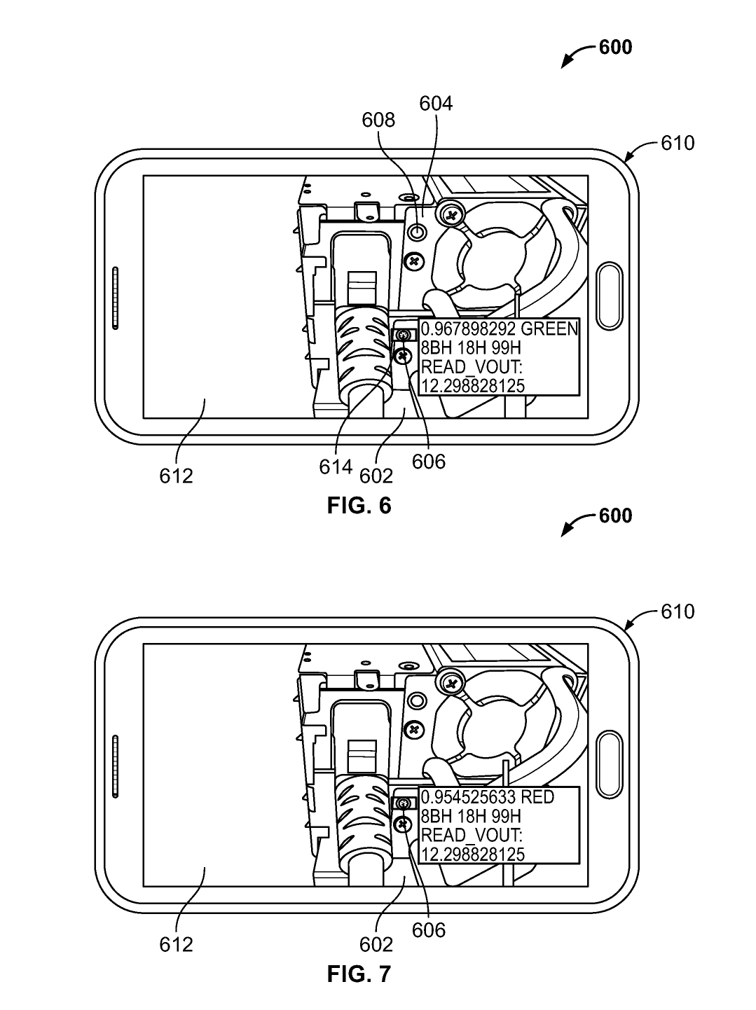

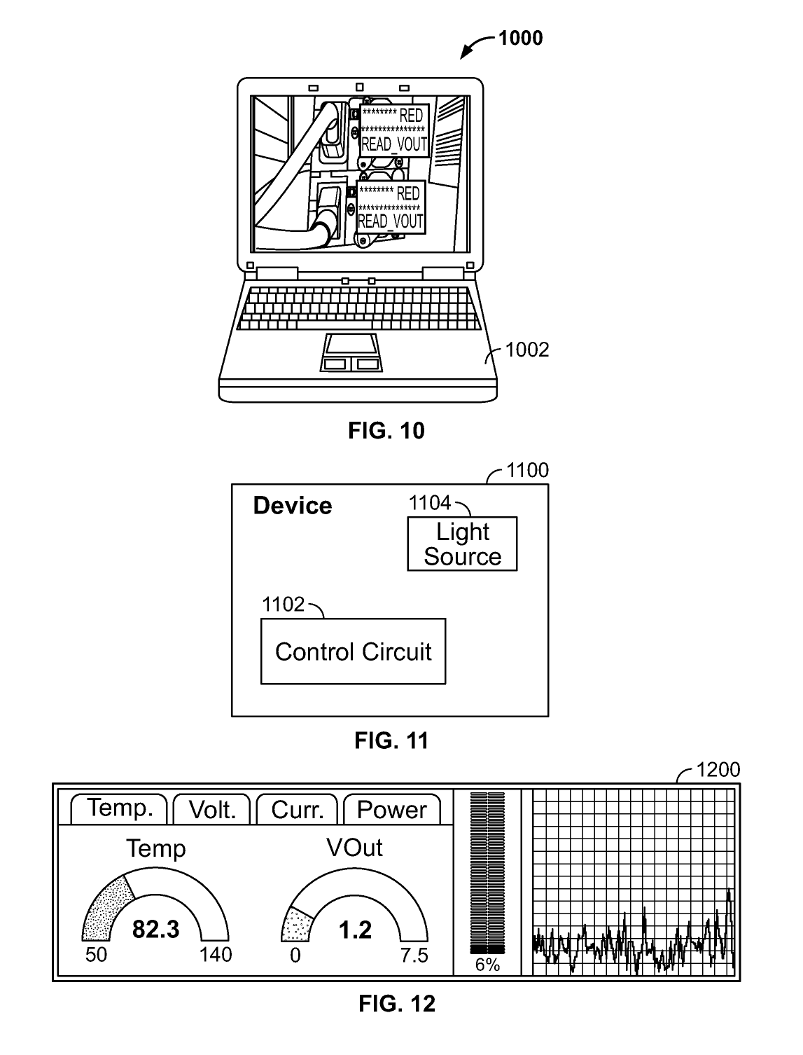

The device 300 may include any suitable device having a camera. For example, the device 300 may include one or more smartphones (as shown in FIGS. 6-9), tablets, laptops (as shown in FIG. 10), and/or another suitable wireless device. In other embodiments, the device 300 may include one or more wired personal computers, computer servers, etc. In some examples, the device 300 may be a camera including the software application 310 and/or communication means to communicate the captured series of light pulses to another device.

The software application 310 (e.g., a program module, etc.) may be executed by the processor 306. Program modules may include routines, programs, objects, components, data structures, etc., that may perform particular tasks, etc. Some example embodiments may include a distributed computing environment where some processes may be performed by remote processing devices that may be linked through a communications network. Program modules may be located in local and/or remote computer storage mediums including memory storage devices.

The device 300 may be implemented using a single processor, multiple processors on a single system, multiple processors across systems that may be in a local or distributed system, etc.

The memory 308 may be memory located on a single device, shared between multiple devices, etc. The memory 308 may be located within the same system as the processor 306 (including, e.g., onboard memory in the processors, etc.) as shown in FIG. 3, or may be located externally. The memory 308 may include volatile memory, nonvolatile memory, ROM, RAM, one or more hard disks, magnetic disk drives, optical disk drives, removable memory, non-removable memory, magnetic tape cassettes, flash memory cards, CD-ROM, DVDs, cloud storage, etc.

In addition to the memory 308, the device 300 may include and/or may be configured to receive one or more non-transitory computer readable mediums. For example, the device 300 may include a DVD player or the like to read DC-ROMs, DVDs, etc., USB port(s) or the like to receive flash memory, etc.

The software application 310 may be stored in any suitable location in the memory 308 and may or may not be stored in the same memory. For example, the software application 310 may be stored in memory on a single device, a server, etc., may be shared between multiple systems, etc. The memory 308 and/or non-transitory computer readable medium may store the software application 310, operating systems, other software applications, program data, etc.

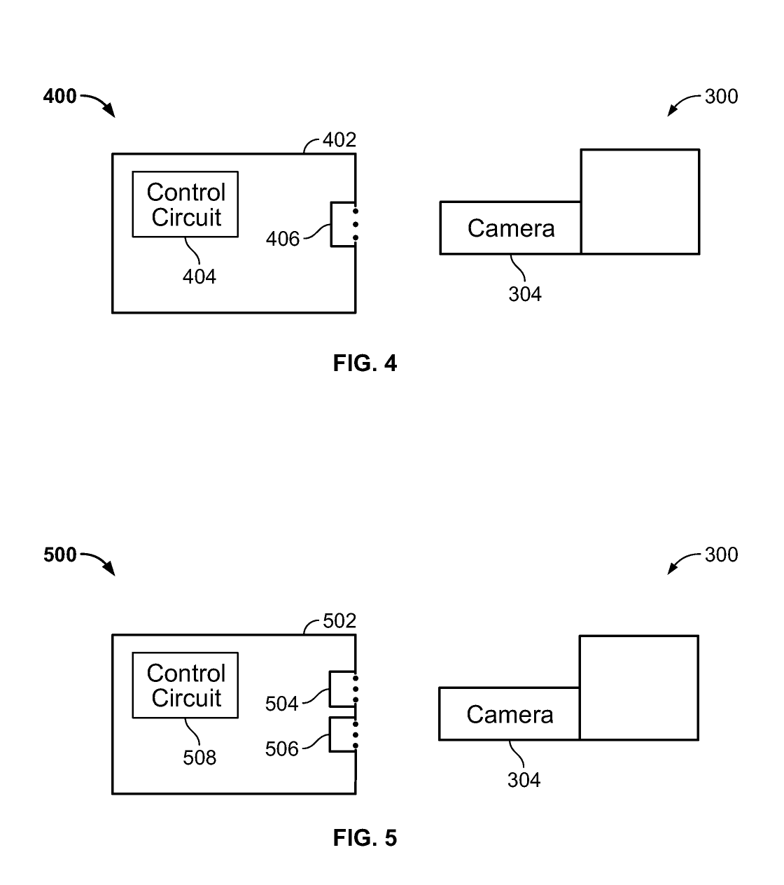

FIG. 4 illustrates an example system 400 including a power supply 402 having operating parameter(s), a light source 406, a control circuit 404 coupled to the power supply 402 and the light source 406, and the device 300 of FIG. 3. The control circuit 404 and the light source 406 are substantially similar to the control circuit 104 and the light source 106 of FIG. 1. Although not shown in FIG. 4, the power supply 402 includes one or more power circuits for converting an input voltage and current to an output voltage and current.

As shown in FIG. 4, the control circuit 404 is positioned in the power supply 402. Alternatively, the control circuit 404, a portion of the control circuit 404, etc. may be positioned external to the power supply 402. As such, the control circuit 404 may be a system control circuit for the power supply 402 and/or other suitable circuits external, remote, etc. to the power supply 402.

In the example embodiment of FIG. 4, the light source 406 is coupled to an interior side of an external wall of the power supply 402. Alternatively, the light source 406 may be positioned in another suitable location relative to the power supply 402. For example, the light source 406 may be positioned on another wall of the power supply 402, remote from the power supply 402, etc. In some embodiments, the light source 406 may be fixed in a particular location (e.g., on the external wall of the power supply 402). In other embodiments, the light source 406 may be moveable.

As shown in FIG. 4, the camera 304 is positioned adjacent the light source 406 to capture the series of light pulses generated by the light source 406. In some examples, the camera 304 may be mobile such that the camera 304 (and in some cases the device 300) may be moved to various positions depending on the location of the light source 406.

In some examples, the device 300 may communicate information to the power supply 402. In such cases, the power supply 402 and device 300 may include bi-directional communication capabilities. For example, the device 300 may include a light source (e.g., an LED, etc.) for generating a series of light pulses and the power supply 402 may include a camera and a software application (e.g., similar to the software application 310, etc.) for decoding the series of light pulses from the device 300. Alternatively and additionally, other suitable methods and/or components for communicating may be employed if desired.

In some examples, a power supply may include multiple light sources each capable of generating a series of light pulses to represent one or more data sequences (as explained above). In such cases, the device 300 may be capable of capturing a series of light pulses generated by more than one light source, and decoding each series of light pulses from the different light sources.

For example, FIG. 5 illustrates another system 500 including the device 300 of FIG. 3 and a power supply 502 substantially similar to the power supply 402. As shown in FIG. 5, the system 500 includes a control circuit 508 and two light sources 504, 506 coupled to a wall of the power supply 502. The control circuit 508 may activate each light source 504, 506 to generate a series of light pulses from each light source (as explained above). The light pulses may represent one particular data sequence for the power supply 502, separate data sequences for the power supply 502, etc. The camera 304 may capture each series of light pulses and the software application 310 (not shown in FIG. 5) may decode each series of light pulses into data representing operating parameter(s) of the power supply 502 as explained above.

If, for example, the light sources 504, 506 are used to generate a series of light pulses representing one particular data sequence for the power supply 502, each light source may represent one or more bits of the data sequence. In some examples, the light source 504 may represent a first bit, a third bit, etc. and the light source 506 may represent a second bit, a fourth, etc. In other examples, the light source 504 may represent the first four bits of a byte and the light source 506 may represent the last four bits of the byte. Additionally, each bit value may be represented by a particular light source being activated and/or deactivated. For example, if a light source is on, the bit value may be “1” and if a light source is off, the bit value may be “0.”

For exemplary purposes only, the light sources 504, 506 may follow the following protocol to communicate an encoded operating parameter of the power supply 502. A data sequence (representing the encoded operating parameter) may have a byte having the binary value of “0111 0010” (e.g., a hexadecimal value of “72”). In such a case, the light source 504 may represent the first bit, the third bit, the fifth bit, and the seventh bit by being deactivated (representing a “0” value), activated (representing a “1” value), deactivated, and activated, respectively. The light source 506 may represent the second bit, the fourth bit, the sixth bit, and the eighth bit by being activated (representing a “1” value), activated, deactivated (representing a “0” value), and deactivated, respectively.

In other example embodiments, a particular color of the light sources 504, 506 may represent two bits of a byte. As such, the light source 504 may represent the first two bits of the byte, the light source 506 may represent the next two bits of the byte, the light source 504 may represent the next two bits, etc. For example, a green light pulse may represent “01”, an orange light pulse may represent “10” and a red light pulse may represent “11.” In this case, if a byte had the binary value of “1101 1000” (e.g., a hexadecimal value of “D8”), the light source 504 may be activated to generate a red light pulse and the light source 506 may be activated to generate a green light pulse, and then the light source 504 may be activated to generate an orange light pulse and the light source 506 may be deactivated to represent “00.”

In other examples, systems may include two or more power supplies, each having a light source capable of generating a series of light pulses to represent a data sequence (as explained above). In such cases, a device may be capable of capturing a series of light pulses generated by more than one power supply, and decoding each series of light pulses from the different light sources.

For example, FIG. 6 illustrates a system 600 including a power supply 602 having an LED 606, a power supply 604 having an LED 608, and a device 610. The power supplies 602, 604 are substantially similar to the power supply 100 of FIG. 1. As such, each power supply 602, 604 includes a control circuit (not shown) to monitor operating parameter(s) of its respective power supply 602, 604, encode the operating parameter(s) into a data sequence, and activate its respective LED 606, 608 to generate a series of light pulses to represent the data sequence as explained above. Alternatively, each power supply 602, 604 may include a portion of a control circuit (e.g., a system control circuit, etc.), share one control circuit, etc. for encoding the operating parameter(s), activating the LEDs 606, 608, etc. if desired.

The device 610 of FIG. 6 is a smartphone including a camera (not shown), a display 612, and a software application (not shown). The camera and the software application of FIG. 6 may be substantially similar to the camera 304 and the software application 310 of FIG. 3.

The smartphone 610 is positioned to allow its camera to capture the series of light pulses as explained above. Once the smartphone 610 is positioned in such a manner, the software application may include instructions to allow a user, an object, etc. to highlight one or both LEDs 606, 608 for capturing the series of light pulses. For example, and as shown in FIG. 6, the LED 606 is highlighted by a box 614. In some embodiments, the box 614 may be formed by a user touching the display 612.

Once the series of light pulses from LED 606 is captured, the software application can decode the series of light pulses, store the captured series of light pulses and/or the decoded data from the series of light pulses in memory, communicate the captured series of light pulses and/or the decoded data to another device, etc. as explained above.

As shown in FIG. 6, the display 612 displays data related to a particular light pulse (when that LED is activated) of the series of light pulses, a view of the camera, and data representing the operating parameter(s) of the power supplies 602, 604. For example, the LED 606 of FIG. 6 is activated to generate a light pulse (of the series of light pulses). The display 612 indicates the existing light pulse is “Green” and that the off-time duration between the existing light pulse and the previous light pulse is 0.967898292 seconds. Based on this information, the software application can decode the light pulse (and other light pulses) to determine the output voltage of the power supply 602. As shown in FIG. 6, the display 612 indicates the output voltage of the power supply 602 is 12.298828125 volts.

Additionally and alternatively, the display 612 may show other information relating to the LEDs 606, 608, the power supplies 602, 604, power circuits in the power supplies, the smartphone 610, etc. if desired.

FIG. 7 illustrates the system 600 of FIG. 6 but with the LED 606 generating a different light pulse of the series of light pulses mentioned above. As shown in FIG. 7, the LED 606 generates a red light pulse, not a green light pulse as in FIG. 6. As the light pulse of FIG. 7 is different than the light pulse of FIG. 6, the display 612 of the smartphone 610 indicates the LED 606 is “Red” and that the off-time duration between the existing light pulse and the previous light pulse is 0.964525833 seconds. Based on this information, the software application can decode this light pulse (and other light pulses) to determine the output voltage of the power supply 602 as explained above.

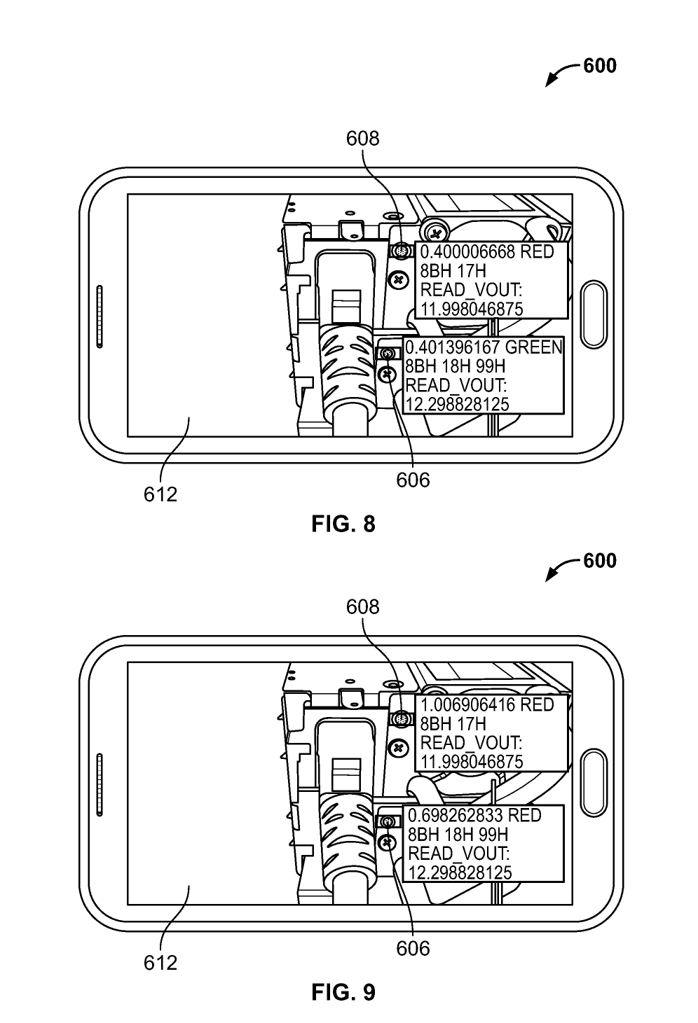

FIGS. 8 and 9 illustrate the system 600 of FIG. 6, but with both LEDs 606, 608 of the power supplies 602, 604, respectively, activated to generate a particular light pulse (of each series of light pulses). For example, the LED 606 includes a green light pulse and the LED 608 includes a red light pulse in FIG. 8 and both LEDs 606, 608 include a red light pulse in FIG. 9. Additionally, similar to FIGS. 6 and 7, the display 612 indicates the off-time duration between the existing light pulse and the previous light pulse of each LED 606, 608, the color of each LED, and the output voltage of each power supply 602, 604.

Although FIGS. 6-9 illustrate the device as a smartphone and the light sources as LEDs, it should be apparent that other suitable devices and/or light sources may be employed without departing from the scope of the disclosure. For example, FIG. 10 illustrates a system 1000 substantially similar to the system 600 of FIGS. 6-9, but including a laptop 1002 having a camera and a software application as explained above.

Additionally, although the methods disclosed herein and FIGS. 1-10 may make reference to one or more power supplies having a control circuit and a light source, it should be apparent to those skilled in the art that the teachings of the disclosure may be employed in any other suitable device including, for example, a computer server, a motor, etc. For example, FIG. 11 illustrates a device 1100 including a control circuit 1102 and a light source 1104. The control circuit 1102 and the light source 1104 may be similar to the control circuit 104 and the light source 106 of FIG. 1. As such, the control circuit 1102 may encode operating parameter(s) of the device 1100 into a data sequence, and activate the light source 1104 to generate a series of light pulses to represent the data sequence for communicating the encoded operating parameter(s) to an object external to the device 1100 as explained above.

As explained above, the operating parameter(s) of the device 1100 may include sensed parameters (e.g., voltage, current, temperature, etc.) of the device 1100, a status of the device 1100, a setting of the device 1100, a status of the control circuit 1102 and/or other component(s) in the device 1100, a setting the control circuit 1102 and/or other component(s) in the device 1100, monitored data, etc. For example, if the device 1100 is a computer server, the device status may indicate a particular condition (e.g., a failure condition, normal operating condition, etc.) of the computer server, components in the computer server, etc. Additionally, the monitored data may indicate data being transferred, utilized, etc. by the computer server and/or other devices in communication with the computer server.

Although FIG. 11 illustrates the control circuit 1102 and the light source 1104 positioned within the device 1100, it should be apparent that the entire control circuit 1102 and/or the light source 1104 may be positioned external the device 1100, portions of the control circuit 1102 and/or the light source 1104 may be positioned external the device 1100, etc.

The light sources disclosed herein may be any suitable light source. For example, the light sources may include one or more light emitting diodes (LEDs) as shown in FIGS. 2 and 6-8, laser diodes (LDs), incandescent light sources, etc. In some embodiments, the LEDs may include infra-red LEDs.

Any one or more of the methods, power supplies, and/or devices disclosed herein may be employed in various applications. The methods may be employed, for example, to communicate value(s) of internal registers, information difficult to access with conventional methods, etc. The methods may be employed in sealed products, wireless products, products in hazardous environments, etc. For example, the methods may be employed to monitor health of, debug, etc. power supplies, etc. The power supplies may be power supplies for computer systems, motors, etc.

Further, the methods may be employed in embedded computing products for debugging; intelligent tracking systems for storage units, shipping containers, etc.; process control systems in dangerous, regulated, etc. environments; factory and test automation systems; home appliances; isolated product testing (e.g., wireless products, etc.); etc.

Employing one or more features explained herein to communicate data from one object to another object may reduce costs, complexity, and power usage compared to conventional methods. This may be due to less required system components, etc.

Additionally, existing systems may be retrofitted to include the one or more features. For example, firmware in control circuits, etc. of existing systems may be updated to include such features. Further, employing the one or more features may allow monitoring of systems that cannot have additional wires attached (e.g., sealed products, products in harsh environments, etc.), cannot utilize conventional wireless communication methods (e.g., Wi-Fi, etc.) due to, for example, electronic noise restrictions, etc. Further, information from the systems may be extracted without affecting other communications pathways.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-26. (canceled)

27. A device comprising a light source, and a control circuit coupled to the light source, the control circuit configured to encode one or more operating parameters of the device into a data sequence, and activate the light source to generate a series of light pulses to represent the data sequence for communicating the encoded one or more operating parameters to an object external to the device.

28. The device of claim 27 wherein the one or more operating parameters include at least one of a sensed output voltage, a sensed output current, a sensed input voltage, a sensed input current, a device setting, a device status, a control circuit setting, and a control circuit status.

29. The device of claim 28 wherein the light source includes one or more LEDs.

30. The device of claim 27 wherein the data sequence includes a first portion and a second portion, wherein the series of light pulses includes at least three light pulses having an off-time between each light pulse, and wherein an off-time between one pair of light pulses is different than an off-time between another pair of light pulses to represent the first portion of the data sequence and the second portion of the data sequence.

31. The device of claim 27 wherein the data sequence includes a first portion and a second portion, and wherein the series of light pulses includes a first light pulse having a first color and a second light pulse having a second color to represent the first portion of the data sequence and the second portion of the data sequence.

32. The device of claim 27 wherein the device includes at least one of a power supply, a computer server, and a motor.

33. A method for communicating data from a device to an object external to the device, the method comprising:
encoding one or more operating parameters of the device into a data sequence, and
activating a light source of the device to generate a series of light pulses to represent the data sequence to communicate the encoded one or more operating parameters to an object external to the device.

34. The method of claim 33 wherein activating the light source includes activating the light source to generate a first light pulse having a first color and activating the light source to generate a second light pulse having a second color different than the first color to represent a first portion of the data sequence and a second portion of the data sequence.

35. The method of claim 33 wherein activating the light source includes activating the light source to generate at least three light pulses having an off-time between each light pulse, wherein an off-time between one pair of light pulses is different than an off-time between another pair of light pulses to represent a first portion of the data sequence and a second portion of the data sequence.

36. A device comprising a processor, memory, a camera, and a software application stored in said memory and executable by the processor, the software application configured to decode a series of light pulses from a light source of another device captured by the camera into data representing one or more operating parameters of the other device.

37. The device of claim 36 wherein said device includes at least one of a smartphone, a laptop, and a tablet and said other device includes at least one of a power supply, a computer server, and a motor.

38. The device of claim 36 wherein said memory is configured to store the captured series of light pulses.

39. The device of claim 36 wherein the software application is configured to decode the captured series of light pulses in response to a defined event.

40. The device of claim 39 wherein the defined event includes at least one of a user command, a sensed parameter, and a period of time.

41. The device of claim 39 wherein the software application is configured to decode the captured series of light pulses in real-time.

42-48. (canceled)
